(19) United States
(12) Patent Application Publication
(10) Pub. No.: US 2011/0271586 A1
(43) Pub. Date: Nov. 10, 2011

(54) TERPOLYMER AND USE THEREOF FOR IMPROVING THE COLD FLOW PROPERTIES OF MIDDLE DISTILLATE FUELS

(75) Inventors: Frank-Olaf MÄHLING, Mannheim (DE); Jan Strittmatter, Mannheim (DE); Irene Trötsch-Schaller, Bissersheim (DE); Ivette Garcia Castro, Ludwigshafen (DE); Thomas Zelinski, Neuleiningen (DE)

(73) Assignee: BASF SE, Ludwigshafen (DE)

(21) Appl. No.: 13/101,426

(22) Filed: May 5, 2011

Related U.S. Application Data
(60) Provisional application No. 61/332,222, filed on May 7, 2010.

(51) Int. Cl. C10L 1/198; C08F 218/08; C08F 220/18

(52) U.S. Cl. 44/393; 526/329; 526/331

(57) ABSTRACT

A terpolymer formed from (A) ethylene, (B) (i) C₂- to C₁₄-alkenyl esters of one or more aliphatic C₁- to C₂₀-monocarboxylic acids or (ii) C₁- to C₂₄-alkyl esters of acrylic acid or methacrylic acid and (C) olefinically unsaturated hydrocarbons selected from (iii) five- to seven-membered cycloalkenes and (iv) α-olefins having 6 to 20 carbon atoms. The terpolymer mentioned is suitable as a cold flow improver in middle distillate fuels. It lowers the lower mixing temperature of cold flow improver additives into middle distillate fuels and improves the filterability of middle distillate fuels comprising cold flow improver additives.

### DESCRIPTION

The present invention relates to a terpolymer formed from

(A) 70 to 94.95 mol % of ethylene,

(B) 5 to 25 mol % of (i) a C₂- to C₁₄-alkenyl ester of one or more aliphatic C₁- to C₂₀-monocarboxylic acids or (ii) one or more C₁- to C₂₄-alkyl esters of acrylic acid or methacrylic acid and

(C) 0.05 to 5 mol % of an olefinically unsaturated hydrocarbon selected from (iii) five- to seven-membered cycloalkenes which may comprise one or more nitrogen, oxygen and/or sulfur ring atoms and/or bear one or more C₁- to C₆-alkyl substituents, and (iv) α-olefins having 6 to 20 carbon atoms,

where all monomer components together add up to 100 mol %.

The present invention further relates to the use of this terpolymer for improving the cold flow properties of middle distillate fuels, for lowering the lower mixing temperature of cold flow improver additives into middle distillate fuels and for improving the filterability of middle distillate fuels comprising cold flow improver additives.

The present invention further also relates to middle distillate fuels with a content of such a terpolymer.

Middle distillate fuels of fossil origin, especially gas oils, diesel oils or light heating oils, which are obtained from mineral oil, have different contents of paraffins depending on the origin of the crude oil. At low temperatures, there is precipitation of solid paraffins at the cloud point (“CP”). In the course of further cooling, the platelet-shaped n-paraffin crystals form a kind of “house of cards structure” and the middle distillate fuel ceases to flow even though its predominant portion is still liquid. The precipitated n-paraffins in the temperature range between cloud point and pour point (“PP”) considerably impair the flowability of the middle distillate fuels; the paraffins block filters and cause irregular or completely interrupted fuel supply to the combustion units. Similar disruptions occur in the case of light heating oils.

It has long been known that suitable additives can modify the crystal growth of the n-paraffins in middle distillate fuels. Very effective additives prevent middle distillate fuels from solidifying even at temperatures a few degrees Celsius below the temperature at which the first paraffin crystals crystallize out. Instead, fine, readily crystallizing, separate paraffin crystals are formed, which, even when the temperature is lowered further, pass through filters in motor vehicles and heating systems, or at least form a filtercake which is permeable to the liquid portion of the middle distillates, so that disruption-free operation is ensured. The effectiveness of the flow improvers is typically expressed, in accordance with European standard EN 116, indirectly by measuring the cold filter plugging point (“CFPP”). Such cold flow improvers or middle distillate flow improvers (“MDFIs”) which have already been used for some time are, for example, ethylene-vinyl carboxylate copolymers such as ethylene-vinyl acetate copolymers (“EVA”).

One disadvantage of these additives is that the paraffin crystals modified in this way, owing to their higher density compared to the liquid portion, tend to settle out more and more at the bottom of the vessel in the course of storage of the middle distillate fuel. As a result, a homogeneous low-paraffin phase forms in the upper part of the vessel, and a biphasic paraffin-rich layer at the bottom. Since the fuel is usually drawn off just above the vessel bottom both in vehicle fuel tanks and storage or supply tanks of mineral oil dealers, there is the risk that the high concentration of solid paraffins leads to blockages of filters and metering devices. The further the storage temperature is below the precipitation temperature of the paraffins, the greater this risk becomes, since the amount of paraffin precipitated increases with falling temperature. In particular, fractions of biodiesel also enhance this undesired tendency of the middle distillate fuel to paraffin sedimentation. By virtue of the additional use of paraffin dispersants or wax antisettling additives (“WASAs”), the problems outlined can be reduced.

Additives for improving the cold performance of newer-generation middle distillate fuels are, for example, the terpolymers, known from DE 196 20 119 C1 (1), formed from ethylene, the vinyl ester of one or more aliphatic C₂- to C₂₀-monocarboxylic acids and bicyclo[2.2.1]hept-2-ene (norbornene) or norbornene derivatives, in the composition of which in general the proportion by weight of vinyl ester is 5 to 40% by weight and the proportion by weight of norbornene or norbornene derivatives is 0.5 to 30% by weight. For the specifically disclosed experimental examples with terpolymers formed from ethylene, vinyl acetate and norbornene, the proportion by weight of vinyl acetate is 24.0 to 30.1% by weight and that of norbornene 7.7 to 14.8% by weight.

EP 1 391 498 A1 (2) describes vinylic polymers which comprise particular amounts of components insoluble in hexane at particular temperatures as flow improvers for fuel oils. These vinylic polymers are formed especially from ethylene and at least one vinylic monomer. Such vinylic monomers may be unsaturated esters, α-olefins or “other vinylic monomers”. Examples given of unsaturated esters include vinyl acetate, vinyl propionate and methyl (meth)acrylate, examples given of α-olefins include propylene, 1-butene and higher homologs, and examples given of “other vinylic monomers” include alicyclic hydrocarbon-vinyl monomers such as cyclohexene, (di)cyclopenta-diene, norbornene, pinene, indene or vinylcyclohexene. Specific terpolymers disclosed are polymers formed from ethylene, vinyl acetate and vinyl neodecanoate (in a molar ratio of 84:15:1), formed from ethylene, vinyl acetate and vinyl 2-ethylhexanoate (in a molar ratio of 83:15:2), formed from ethylene, vinyl acetate and 4-methylpent-1-ene (with unspecified molar ratios) and formed from ethylene, vinyl acetate and 2-ethylhexyl acrylate (with unspecified molar ratios).

Japanese published specification 63-113097 A (3) discloses fuel oil compositions with a content of particular copolymers as cold flow improvers. For instance, as example B-1, an ethylene-vinyl acetate copolymer with a vinyl acetate content of 33.1% by weight and a number-average molecular weight of 2260 is used, which has been prepared in the presence of the molecular weight regulator methylcyclohexane.

It was an object of the present invention to provide products which bring about very good cold performance in middle distillate fuels. More particularly, the CFPP for these fuels should be lowered effectively. At the same time, these products should lower the lower mixing temperature of cold flow improver additives into middle distillate fuels and improve the filterability of middle distillate fuels comprising cold flow improver additives.

The object is achieved in accordance with the invention by the terpolymer, cited at the outset, formed from components (A), (B) and (C).

The inventive terpolymer is preferably formed from

(A) 80 to 91.95 mol %, especially 85 to 89.93 mol %, of ethylene,

(B) 8 to 19 mol %, especially 10 to 14.6 mol %, of component (B) and

(C) 0.05 to 1 mol %, especially 0.07 to 0.4 mol %, of component (C).

The olefinically unsaturated hydrocarbon of component (C) is either the cycloalkene mentioned under (iii) or the long-chain α-olefin mentioned under (iv). Component (C) generally comprises only one olefinic double bond. Aromatic structural elements or more than one olefinically unsaturated double bond are typically not present in component (C).

The five-, six- or seven-membered cycloalkene used as component (C) of embodiment (iii) is monocyclic; bi- or polycyclic representatives are unsuitable. In general, this cycloalkene comprises one polymerizable olefinic double bond. Typical representatives of such cycloalkenes are cyclopentene, 1-methylcyclopentene, 3-methylcyclopentene, 4-methylcyclopentene, 1,2-dimethylcyclopentene, 1,3-dimethylcyclopentene, 1,4-dimethylcyclopentene, cyclohexene, 1-methylcyclohexene, 3-methylcyclohexene, 4-methylcyclohexene, 1,2-dimethylcyclohexene, 1,3-dimethylcyclohexene, 1,4-dimethyl-cyclohexene, cycloheptene, 1-methylcycloheptene, 3-methylcycloheptene, 4-methylcycloheptene and 5-methylcycloheptene, among which, however, cyclohexene is preferred.

The α-olefin used as component (C) of embodiment (iv) is generally linear, i.e. unbranched. In general, this α-olefin comprises, aside from the one terminal polymerizable olefinic double bond, no further unsaturations. This α-olefin preferably has 8 to 19, preferably 10 to 18, in particular 12 to 16, carbon atoms. Typical representatives of such α-olefins are 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene and 1-eicosene, among which, however, 1-dodecene, 1-tetradecene and 1-hexadecene are preferred.

Suitable C₂- to C₁₄-alkenyl esters of one or more aliphatic C₁- to C₂₁-monocarboxylic acids for embodiment (i) of component (B) are especially the vinyl and propenyl esters of aliphatic monocarboxylic acids having 2 to 18 carbon atoms, the hydrocarbon radical of which may be linear or branched. Among these, the vinyl esters are preferred. Irrespective of the alkenyl radical, particularly preferred monocarboxylic acids are those having 2 to 16, especially 2 to 10, carbon atoms. Among the carboxylic acids with a branched hydrocarbon radical, preference is given to those whose branch is in the α-position to the carboxyl group, the α-carbon atom more preferably being tertiary, i.e. the carboxylic acid is what is known as a neocarboxylic acid. However, the hydrocarbon radical of the carboxylic acid is preferably linear. Examples of suitable alkenyl carboxylates (i) are vinyl acetate, vinyl propionate, vinyl butyrate, vinyl 2-ethylhexanoate, vinyl neopentanoate, vinyl hexanoate, vinyl neononanoate, vinyl neodecanoate and the corresponding propenyl esters, preference being given to the vinyl esters.

Suitable C₁- to C24-alkyl esters of acrylic acid or methacrylic acid for embodiment (ii) of component (B) are especially the esters of acrylic and methacrylic acid with C₁- to C₁₄-alkanols, especially C₁- to C₁₄-alkanols, in particular with methanol, ethanol, propanol, isopropanol, n-butanol, sec-butanol, isobutanol, tert-butanol, pentanol, hexanol, heptanol, octanol, 2-ethylhexanol, nonanol, 2-propylheptanol, decanol and isotridecanol.

The inventive terpolymer may also comprise two or more monomer species (i) and/or (ii) of component (B), i.e. two or more different alkenyl carboxylates (i) or two or more different acrylic or methacrylic esters (ii) or at least one alkenyl carboxylate (i) and at least one acrylic or methacrylic ester (ii) in copolymerized form, in which case these differ in the alkenyl function and/or in the carboxylic acid group and/or in the alcohol radical.

A particularly preferred component (B) is vinyl acetate.

In a particularly preferred embodiment, the inventive terpolymer is formed from ethylene, vinyl acetate as component (B), and cyclohexene, 1-dodecene, 1-tetradecene or 1-hexadecene as component (C).

The inventive terpolymer is most preferably formed from

(A) 85 to 89.93 mol %, especially 85 to 89.92 mol %, of ethylene,

(B) 10 to 14.6 mol %, especially 10 to 14.7 mol %, of vinyl acetate and

(C) 0.07 to 0.4 mol %, especially 0.08 to 0.3 mol %, of cyclohexene, 1-dodecene, 1-tetradecene or 1-hexadecene.

The inventive terpolymer can be prepared by known and customary polymerization techniques. The mixture of the three monomer components (A), (B) and (C) can be polymerized in solution, in suspension or preferably in substance. In general, a high-pressure polymerization process is used for this purpose, as described, for example, in EP-A 007 590, in DE-A 31 41 507 and in the documents cited therein, and works at pressures of 50 to 5000 bar, especially 500 to 2500 bar, in particular 1000 to 2300 bar, typically 1600 to 2000 bar, and at temperatures of 50 to 450° C., especially 100 to 350° C., in particular 150 to 250° C., typically 200 to 240° C. A suitable polymerization apparatus for this purpose is especially a continuous tubular reactor. The polymerization is preferably initiated by initiators which decompose to free radicals, for which air or oxygen are suitable, optionally in the presence of additionally supplied organic peroxides and/or hydroperoxides. Useful organic peroxides or hydroperoxides include, for example, diisopropylbenzene hydroperoxide, cumene hydroperoxide, methyl isobutyl ketone peroxide, di-tert-butyl peroxide and tert-butyl perisononanoate. In addition, it is possible also to use suitable regulators such as aliphatic aldehydes or ketones or else hydrogen in the polymerization.

The inventive terpolymer preferably has a number-average molecular weight (Mₙ) in the range from 1000 to 5000, especially from 1500 to 2500, or alternatively a weight-average molecular weight of 2000 to 10 000, especially of 3500 to 5000 (determined in each case by gel permeation chromatography).

The inventive terpolymer serves as a novel efficient cold flow improver in middle distillate fuels. In the context of the present invention, middle distillate fuels shall be understood to mean middle distillate fuels boiling in the range from 120 to 450° C. Such middle distillate fuels are used in particular as diesel fuel, heating oil or kerosene, particular preference being given to diesel fuel and heating oil.

Middle distillate fuels (also referred to hereinafter as “middle distillates” for short) refer to fuels which are obtained by distilling crude oil as the first process step and boil within the range from 120 to 450° C. Preference is given to using low-sulfur middle distillates, i.e. those which comprise less than 350 ppm of sulfur, especially less than 200 ppm of sulfur, in particular less than 50 ppm of sulfur. In special cases, they comprise less than 10 ppm of sulfur; these middle distillates are also referred to as “sulfur-free”. They are generally crude oil distillates which have been subjected to refining under hydrogenating conditions and therefore comprise only small proportions of polyaromatic and polar compounds. They are preferably those middle distillates which have 90% distillation points below 370° C., in particular below 360° C. and in special cases below 330° C.

Low-sulfur and sulfur-free middle distillates may also be obtained from relatively heavy crude oil fractions which cannot be distilled under atmospheric pressure. Typical conversion processes for preparing middle distillates from heavy crude oil fractions include: hydrocracking, thermal cracking, catalytic cracking, coking processes and/or visbreaking. Depending on the process, these middle distillates are obtained in low-sulfur or sulfur-free form, or are subjected to refining under hydrogenating conditions.

The middle distillates preferably have aromatics contents of below 28% by weight, especially below 20% by weight. The content of normal paraffins is between 5% by weight and 50% by weight, preferably between 10 and 35% by weight.

In the context of the present invention, middle distillate fuels shall also be understood here to mean those fuels which can either be derived indirectly from fossil sources such as mineral oil or natural gas, or else are prepared from biomass via gasification and subsequent hydrogenation. A typical example of a middle distillate fuel which is derived indirectly from fossil sources is the GTL (“gas-to-liquid”) diesel fuel obtained by means of Fischer-Tropsch synthesis. A middle distillate is prepared from biomass, for example via the BTL (“biomass-to-liquid”) process, and can be used either alone or in a mixture with other middle distillates as fuel. The middle distillates also include hydrocarbons which are obtained by the hydrogenation of fats and fatty oils. They comprise predominantly n-paraffins.

The qualities of the heating oils and diesel fuels are laid down in more detail, for example, in DIN 51603 and EN 590 (cf. also Ullmann's Encyclopedia of Industrial Chemistry, 5th edition, volume A12, p. 617 ff.).

The inventive terpolymer may, in addition to the use thereof in the middle distillate fuels of fossil, vegetable or animal origin mentioned, which are essentially hydrocarbon mixtures, also be used in mixtures of such middle distillates with biofuel oils (biodiesel) to improve the cold flow performance. In the context of the present invention, such mixtures are also encompassed by the term “middle distillate fuel”. They are commercially available and usually comprise the biofuel oils in minor amounts, typically in amounts of 1 to 30% by weight, especially of 3 to 10% by weight, based on the total amount of middle distillate of fossil, vegetable or animal origin and biofuel oil.

Biofuel oils are generally based on fatty acid esters, preferably essentially on alkyl esters of fatty acids which derive from vegetable and/or animal oils and/or fats. Alkyl esters are typically understood to mean lower alkyl esters, especially C₁- to C₄-alkyl esters, which are obtainable by transesterifying the glycerides, especially triglycerides, which occur in vegetable and/or animal oils and/or fats, by means of lower alcohols, for example ethanol or in particular methanol (“FAME”). Typical lower alkyl esters based on vegetable and/or animal oils and/or fats, which find use for this purpose as biofuel oil or components, are, for example, sunflower methyl ester, palm oil methyl ester (“PME”), soybean oil methyl ester (“SME”) and especially rapeseed oil methyl ester (“RME”).

The inventive terpolymer brings about a distinct improvement in the cold flow performance of the middle distillate fuel or of the middle distillate-biofuel oil mixture, i.e. a lowering especially of the CFPPs, but also of the CPs and/or the PPs, substantially irrespective of the origin or the composition of the fuel. The precipitated paraffin crystals are generally kept suspended more effectively, such that there is no blockage or filters and lines by such sediments. In most cases, the inventive terpolymer has a good breadth of action and thus has the effect that the precipitated paraffin crystals are dispersed very effectively in a wide variety of different fuels.

The inventive terpolymer additionally brings about a lowering of the lower mixing temperature of cold flow improver additives into middle distillate fuels. Owing to their chemical structure, cold flow improver additives frequently have to be added to the refinery streams at a particular elevated minimum temperature, in order to enable pumped feeding and complete dissolution in the middle distillate fuel and the homogenization thereof. This parameter—also defined as the lower mixing temperature—should be at a minimum, in order to avoid costly heating of the cold flow improver storage tanks in the refineries.

The inventive terpolymer additionally brings about an improvement in the filterability of middle distillate fuels comprising cold flow improver additives. This is because the presence of prior art additives frequently leads to a deterioration in the filterability of middle distillates, which is manifested in longer filtration times, as a result of which the employability and the maximum dosage rate of the additives is restricted.

Equally, the use of the inventive terpolymer, in addition to the improvement in the cold flow properties of middle distillate fuels and in the handling, with cold flow improver additives or with middle distillates comprising cold flow improver additives can improve a series of further fuel properties. By way of example, merely the additional effect as an anticorrosive or the improvement in the oxidation stability shall be mentioned here.

The present invention also provides middle distillate fuels which comprise 10 to 5000 ppm by weight, especially 25 to 1500 ppm by weight, in particular 50 to 750 ppm by weight, of the inventive terpolymer.

The middle distillate fuels mentioned may comprise, as further additives in amounts customary therefor, further cold flow improvers, paraffin dispersants, conductivity improvers, anticorrosion additives, lubricity additives, antioxidants, metal deactivators, antifoams, demulsifiers, detergents, cetane number improvers, solvents or diluents, dyes or fragrances or mixtures thereof. Further cold flow improvers are described, for example, in WO 2008/113757 A1. The remaining further additives mentioned above are, incidentally, familiar to the person skilled in the art and therefore need not be explained any further.

The examples which follow are intended to illustrate the present invention, without restricting it.

### EXAMPLES

### Fuels Used:

To demonstrate the effectiveness of the inventive terpolymer as an additive in diesel fuels, four commercial low-sulfur winter diesel fuels (test oils DF1 to DF4) were used, which meet the standard EN 590 and have the following properties:

DF1: CP (DIN EN 23015): −7.5° C.

CFPP (DIN EN 116) −10° C.

Density at 15° C. (EN ISO 1285): 839.7 kg/m³

DF2: CP (DIN EN 23015): −10.8° C.

CFPP (DIN EN 116) −12° C.

Density at 15° C. (EN ISO 1285): 828.7 kg/m³

DF3: CP (DIN EN 23015): −7.7° C.

CFPP (DIN EN 116) −8° C.

Density at 15° C. (EN ISO 1285): 832.7 kg/m³

DF4: CP (DIN EN 23015): −6.7° C.

CFPP (DIN EN 116) −10° C.

Density at 15° C. (EN ISO 1285): 837.9 kg

### Additives Used:

The ter- or copolymers used can be characterized as follows, T-1, T-2, T-3 and T-4 having been used in accordance with the invention and C-5 for comparison:

T-1: Composition: 70.1% by weight (87.88 mol %) of ethylene

29.4% by weight (12.01 mol %) of vinyl acetate

0.5% by weight (0.11 mol %) of 1-dodecene

Molecular weights: Mₙ=1955, M_{w}=4081

Dynamic viscosity: 70 mPas

prepared by high-pressure polymerization at 218° C. and 1705 bar

T-2: Composition: 69.9% by weight (87.81 mol %) of ethylene

29.6% by weight (12.11 mol %) of vinyl acetate

0.5% by weight (0.08 mol %) of 1-hexadecene

Molecular weights: Mₙ=1933, M_{w}=4214

Dynamic viscosity: 70 mPas

prepared by high-pressure polymerization at 219° C. and 1704 bar

T-3: Composition: 70.0% by weight (87.74 mol %) of ethylene

29.6% by weight (12.09 mol %) of vinyl acetate

0.4% by weight (0.17 mol %) of cyclohexene

Molecular weights: Mₙ=2015, M_{w}=4046

Dynamic viscosity: 70 mPas

prepared by high-pressure polymerization at 219° C. and 1700 bar

T-4: Composition: 70.4% by weight (87.94 mol %) of ethylene

29.0% by weight (11.80 mol %) of vinyl acetate

0.6% by weight (0.26 mol %) of cyclohexene

Molecular weights: Mₙ=2059, M_{w}=4303

Dynamic viscosity: 70 mPas

prepared by high-pressure polymerization at 220° C. and 1696 bar

C-5: Composition: 70% by weight of ethylene (87.74 mol %)

30% by weight of vinyl acetate (12.26 mol %)

Molecular weights: Mₙ=2000, M_{w}=4110

Dynamic viscosity: 70 mPas

prepared by high-pressure polymerization at 220° C. and 1700 bar

### Example 1: Determination of the Cold Performance

Table 1 below, containing the cold filter plugging points (“CFPP”) determined according to European standard EN 116, shows that the effect of the inventive terpolymer (T-1, T-2, T-3 and T-4)—according to the test oil used—is slightly better or at least just as good as that of the comparable prior art polymers.

TABLE 1
Determination of the CFPPs [° C.]

| Test oil | DF1 | DF2 | DF3 |
|---|---|---|---|
| Dosage * | 240 ppm | 60 ppm | 120 ppm |
| Additive T-1 | −18 | −25 | −29 |
| Additive T-2 | −16 | −24 | −27 |
| Additive T-3 | −16 | −27 | −30 |
| Additive T-4 | −17 | −28 | −29 |
| Additive C-5 | −17 | −25 | −28 |

* N.B.: Polymers T-1 to T-4 and C-5 were dosed as a 60% by weight solution in solvent naphtha. The respective dosage reported is based on the polymer content of the solution.

### Example 2: Determination of the Filterability Performance

Table 2 below, containing the filterability characteristics (filtration times in seconds) determined according to the standard DGMK 663, shows that the effect of the inventive terpolymer (T-1, T-2, T-3 and T-4) is better than that of the comparable prior art polymers.

TABLE 2
Determination of the
filterability characteristics

| Test oil | DF2 | DF4 |
|---|---|---|
| Dosage | 500 ppm | 500 ppm |
| Blank value (no additive) | 68 s | 74 s |
| Additive T-1 | 97 s | 86 s |
| Additive T-2 | 102 s | 87 s |
| Additive T-3 | 88 s | 83 s |
| Additive T-4 | 91 s | 82 s |
| Additive C-5 | 146 s | 113 s |

1. A terpolymer formed from
(A) 70 to 94.95 mol % of ethylene,
(B) 5 to 25 mol % of (i) a C₂- to C14-alkenyl ester of one or more aliphatic C₁- to C20-monocarboxylic acids or (ii) one or more C₁- to C₂₄-alkyl esters of acrylic acid or methacrylic acid and
(C) 0.05 to 5 mol % of an olefinically unsaturated hydrocarbon selected from (iii) five- to seven-membered cycloalkenes which may comprise one or more nitrogen, oxygen and/or sulfur ring atoms and/or bear one or more C₁- to C₆-alkyl substituents, and (iv) α-olefins having 6 to 20 carbon atoms,
where all monomer components together add up to 100 mol %.

2. A terpolymer according to claim 1, formed from
(A) 80 to 91.95 mol %, especially 85 to 89.93 mol %, of ethylene,
(B) 8 to 19 mol %, especially 10 to 14.6 mol %, of component (B) and
(C) 0.05 to 1 mol %, especially 0.07 to 0.4 mol %, of component (C).

3. A terpolymer according to claim 1 or 2, which comprises, as component (C), cyclohexene or a linear α-olefin having 12 to 16 carbon atoms in copolymerized form.

4. A terpolymer according to claims 1 to 3, formed from ethylene, vinyl acetate as component (B) and cyclohexene, 1-dodecene, 1-tetradecene or 1-hexadecene as component (C).

5. A terpolymer according to claims 1 to 4, formed from
(A) 85 to 89.93 mol % of ethylene,
(B) 10 to 14.6 mol % of vinyl acetate and
(C) 0.07 to 0.4 mol % of cyclohexene, 1-dodecene, 1-tetradecene or 1-hexa-decene.

6. A terpolymer according to claims 1 to 5 with a number-average molecular weight in the range from 1000 to 5000, especially from 1500 to 2500, or with a weight-average molecular weight of 2000 to 10 000, especially of 3500 to 5000.

7. A middle distillate fuel comprising 10 to 5000 ppm by weight of a terpolymer according to claims 1 to 6.

8. The use of a terpolymer according to claims 1 to 6 for improving the cold flow properties of middle distillate fuels.

9. The use of a terpolymer according to claims 1 to 6 for lowering the lower mixing temperature of cold flow improver additives into middle distillate fuels.

10. The use of a terpolymer according to claims 1 to 6 for improving the filterability of middle distillate fuels comprising cold flow improver additives.
